(19) United States
(12) Patent Application Publication
(10) Pub. No.: US 2005/0182711 A1
(43) Pub. Date: Aug. 18, 2005

(54) Method for controlling subscriber accounts in connection with a pre-paid in platform, and a pre-paid mediator

(76) Inventors: Kari Pulkkinen, Helsinki (FI); Kari Pasonen, Espoo (FI)

Correspondence Address: BIRCH STEWART KOLASCH & BIRCH, PO BOX 747, FALLS CHURCH, VA, 22040-0747, US

(21) Appl. No.: 10/512,048

(22) PCT Filed: Apr. 23, 2003
(86) PCT No.: PCT/FI03/00324

(30) Foreign Application Priority Data
Apr. 24, 2002 (FI) 20020795

(51) Int. Cl. G06F 17/60

(52) U.S. Cl. 705/39

(57) ABSTRACT

The invention relates to a method for managing customer accounts in connection with a Pre-Paid platform (8). According to the method the applications (3) communicate with the Pre-Paid platform (8). According to the invention, the applications (3) are arranged to communicate with a proxy (4) and the Pre-Paid platform correspondingly (8) with a charging module (5), in which case the proxy (4) and the charging module (5) communicated with each other in a logically predefined manner, in which case the proxy (4) is used to collect and manage the charging data and related information of the services used by the customers, and the charging module (5) is used to charge the customer's Pre-Paid account, which is located on the Pre-Paid platform (8), or in a system behind it.

The present invention relates to a method, according to claim 1, for managing customer accounts in connection with a Pre-Paid IN platform.

The invention also relates to a Pre-Paid mediator according to claim 12.

Pre-Paid Practice

According to the state of the art, a Pre-Paid platform is used for billing several services. IN (Intelligent Network)-based Pre-Paid services were originally made for billing switched-circuit calls, making it difficult to adapt new services to them. On the other hand, particularly in mobile telephone traffic, Pre-Paid services are used very generally in some countries. Particularly in countries in Southern Europe, the use of the Pre-Paid payment system is extremely widespread. Because this form of operation is so dominant, operators are unwilling to make substantial changes to the basic structure of the system, the Pre-Paid service platform. Other services connected to this system must be implemented, in billing, by simulating normal switched-circuit voice calls.

EP patent application 1100032 discloses a solution for managing service-provider accounts in a Pre-Paid application. The patent does not concern itself with managing customer accounts.

WO publication 00/24161 discloses a solution, in which a Pre-Paid IN is connected in a tailor-made manner to tailor-made telephone network components. The solution cannot be applied to connecting existing network components to a Pre-Paid IN platform.

The present invention is intended to eliminate the defects of the state of the art and to create an entirely new type of method for managing customer accounts in connection with a Pre-Paid IN platform, as well as to create a Pre-Paid mediator.

The invention is based on arranging the applications to communicate with a proxy and the Pre-Paid platform correspondingly with a charging module, so that the proxy and the charging module communicate with each other in a logically predefined manner, in which case the proxy (4) is used to collect and control the rate and other charging data and related information of the services used by the customer, and the charging module (5) is used to bill the customer's Pre-Paid account, which is located on the Pre-Paid platform (8), or in a system behind it.

Here, the term application refers to a technical application (for example, MMS multimedia messaging, SMS short message service, GPRS general packet radio system), which operators provide for their customers, or a content or service, a content provider or service provider provides for their customers, either through the intermediary of he aforesaid operators, or directly.

More specifically, the method according to the invention is characterized by what is stated in the characterizing portion of claim 1.

The Pre-Paid mediator according to the invention is, in turn, characterized by what is stated in the characterizing portion of claim 12.

Considerable advantages are gained with the aid of the invention.

With the aid of the invention it is possible to create a modular system in connection with a Pre-Paid platform, to which the desired number of applications can be easily connected. The system has comprehensive charging models and also permits the comprehensive connection of service providers to the Pre-Paid platform.

Our invention is thus technology-independent and it therefore also independent of equipment manufacturers. Our solution also supports standard solutions and can easily be connected to old telephone-network elements. Thanks to the aforementioned aspects, the system can also be easily configured to correspond to the special characteristics of a network and its elements.

The method does not require the replacement or alteration of existing network elements.

In the following, the invention is examined with the aid of examples of embodiments according to the accompanying drawings.

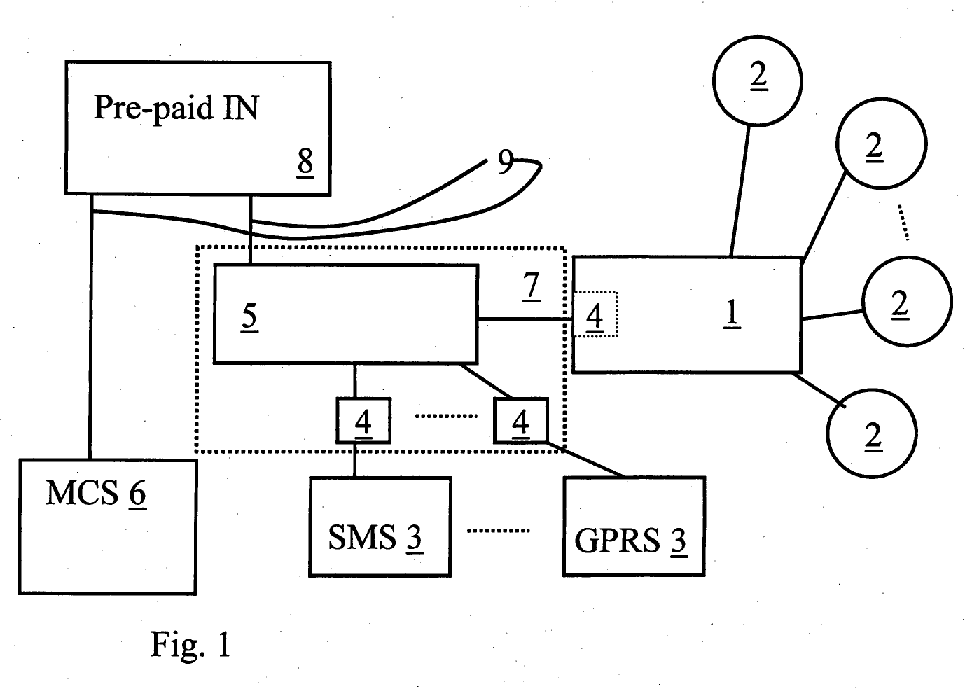

FIG. 1 shows a block diagram of one Pre-Paid mediator according to the invention.

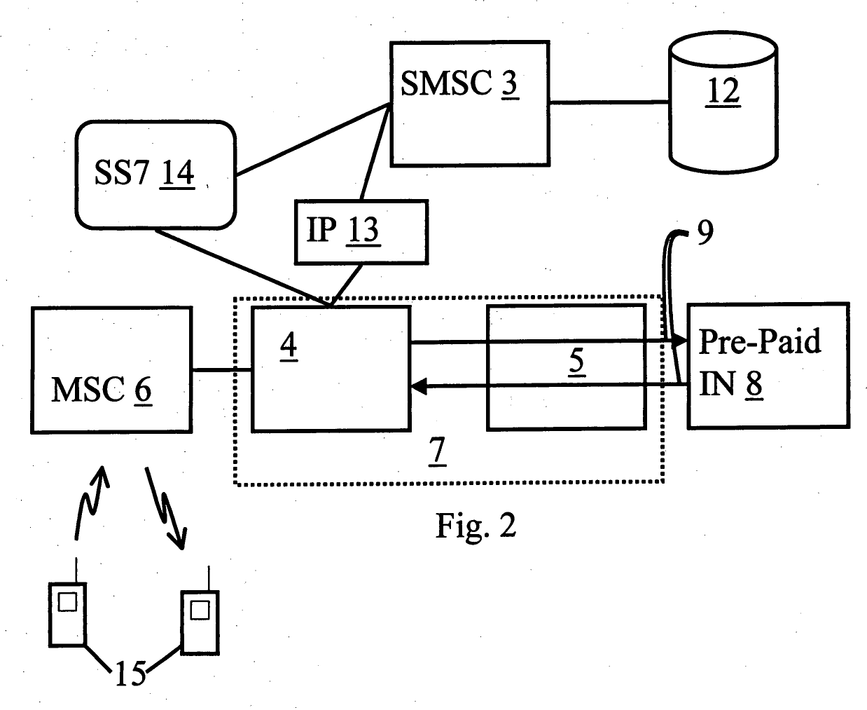

FIG. 2 shows a block diagram of the mediator according to the invention in an SMS application.

Terminology

| | |
|---|---|
| Control system for service providers and customers | 1 |
| Service provider | 2 |
| Service, e.g. GGSN (Gateway GPRS Support Node) | 3 |
| Proxy | 4 |
| Pre-Paid charging module (PCN, Prepaid-charging node) | 5 |
| (MSC Mobile Switching Centre) GSM network | 6 |
| Pre-Paid mediator | 7 |
| Pre-Paid IN | 8 |
| INAP/CAP protocol | 9 |
| Management system for accounts | 12 |
| IP protocol | 13 |
| SS7 protocol | 14 |
| Subscriber, terminal device (e.g., mobile station) | 15 |

According to FIG. 1, the system according to the invention is built around a Pre-Paid IN 8 (Pre-Paid intelligent network centre). The Pre-Paid IN 8 handles the charging of Pre-Paid customer accounts with the aid of an INAP/CAP protocol 9. The operation varies slightly, depending on the kind of protocol currently being used. In INAP signalling, all the intelligence is generally in the IN Pre-Paid system. It takes care of the entire call control and the MSC is only a ‘dumb switch’, i.e. all the call control is transferred to the IN system. On the other hand, in the CAP2 protocol, for example, the external system carries out most of the work referred to above. The method according to the invention is best suited to cases, in which the prepaid aspect is entirely ‘dumb’. Thus, messages come to the Pre-Paid IN over a bus 9, which has a very precisely predefined data-transfer protocol, and which cannot carry out complicated communication or charging implemented with the aid of complicated rules. Thus the elements connected to it, such as the mobile telephone centre 6 and the Pre-Paid mediator 7 should be able to communicate using the given rules. Typically, the protocol is either INAP or CAP. In practice, with the aid of these protocols, calls can only be charged on the basis of their duration. However, the protocol will also permit the transfer of other call-related data, such as, for example, B-subscriber number data and the time and category of the call.

Thus, in FIG. 1, the mobile telephone centre MSC 6 and the mediator 7 according to the invention communicate with the Pre-Paid intelligent centre 8 using an NAP or CAP protocol. The mobile telephone centre transmits data concerning the voice-call data of each customer over the bus 9 to the Pre-Paid intelligent centre 8 while similarly the charging data is sent from the SMS centre 3 and the GPRS centre 3 to the Pre-Paid intelligent centre 8, just as if they were normal voice-call data. An essential feature of a prepaid system is that charging data can be transmitted prior to call connection or an SMS transmission, allowing the system to prevent the provision of services, if there is no money in the account.

The Pre-Paid mediator 7 according to the invention handles the conversion of the service (non-voice-call connection) into a simulated voice call, so that an amount corresponding to the service can be charged from the subscriber's account. At the same time, the system according to the invention produces, if necessary, simulated B-number data in the call detail record, from which the provider of the service (MMS, SMS, GPRS) can be defined afterwards. There is particular benefit from this B-number adding function, if the system configuration incorporates a management and billing system 1 for several service providers 2. In that case, it is easy for a customer, or an operator's customer service to determine, from the B-number data, the basis on which the billing has been carried out.

In turn, it is advantageous for service providers to provide diverse services, as the prepaid payment system ensures that they will receive payment for a service. In other words, the system can prevent services from being provided, if the balance in the Pre-Paid account is insufficient.

The core of the invention is thus the Pre-Paid mediator 7, which is divided into a Pre-Paid charging module 5 and a Pre-Paid proxy 4. To make the system as modular as possible, data transfer between the charging module 5 and the proxy 4 is implemented logically in the same way, irrespective of which service (SMS, GPRS . . . ) 3 the proxy 4 is connected to. In practice, the technical details of the data transfer between the charging module 5 and the proxy 4 typically depend on the type of centre 3 that is connected to the proxy 4.

In the manner described above, an advantageous solution is created particularly for prepaid solutions or services, in which there are several difference technical applications and several service and content providers. By using the arrangement according to the invention, the aforesaid content and service providers do not need to build any kind of support into their own systems in order to handle prepaid charging, because the prepaid charging system according to the invention is generally located in the possession of the operator. Further, by using the arrangement according to the invention, charging for new types of services can be flexibly supported. Examples of these are so-called non-voice services, such as push-SMS content and pull-SMS content types of service.

The division of tasks between the blocks 4 and 5 of the Pre-Paid mediator 7 is as follows:
The proxy 4 has information as to which service the user of the terminal device intends to use. In addition, the proxy 4 sends the charging module 5 data concerning the amount of the service used (transferred data, the number of messages, the type of the messages) and concerning the rating and service code relating to the service in question. The Pre-Paid mediator 7 recognizes the service and adds a defined charging model to it. The service code identifies the used service, which is converted by the module 5 into a form understood by the IN centre 8. In other words, the proxies 4 control the delivery of the service to the customer. The proxy 4 is also in charge of delivering the requested product or service whenever there is a positive balance in the account of the user. The proxy 4 ‘conceals’ the complexity of the data-communications network, the service platforms, the charging models, and rating from the charging module 5 and further from the Pre-Paid IN 8. In other words, the Pre-Paid platform 8 does not necessarily know, nor need it know, what type of data-communications connection (SMS, MMS, GPRS, WWW, IVR, etc.) the subscriber is using for each service, because this information can be found in the proxy 4.
The charging module 5 receives the aforesaid service data and rating and converts the rating parameters of the service into a form (B-number+time) understood by the Pre-Paid IN 8. Next, the charging module 5 uses an INAP or CAP protocol to send the charging information to the Pre-Paid IN 8 over the bus 9. The charging module 5 can also receive the aforesaid charging data directly from the application server 3, which can be, for example, an e-mail server. However, this requires the application server 3 to transmit at least the data that the proxy 4 would do in reality. In other words, in such a case the application server 3 also includes the functions of the proxy 4.
Only the ‘B-number and the ‘call-time’ used’ travel in an INAP message. In practice, the charging module 5 ‘conceals’ the complexity of the proxies 4 from the Pre-Paid IN 8.

FIG. 2 shows an example of the transmission of a text message between two mobile subscriptions, in an environment according to the invention. The mobile telephone centre MSC 6 receives a text-message transmission request from a terminal device 15. Because a voice call is not involved, the message is routed to the proxy 4 and forwarded from there to the charging server 5, which sends the Pre-Paid intelligent centre 8 data concerning a voice call of a certain length and possibly data concerning a certain B-number, in order to identify the service as specifically an SMS service. The Pre-Paid intelligent centre 8 uses an INAP or CAP protocol to provide information as to whether the sending subscriber 15 has an adequate balance and this information triggers the proxy to send the message, for example, through a switched-circuit network (using the SS7 protocol 14), or through a packet-switched network (using the IP protocol 13) to the short-message centre 3, which forwards the short message to the receiving subscriber 15. If the information of the Pre-Paid intelligent centre 8 shows that the sending subscriber's 15 balance is insufficient, the short message is not sent. The Pre-Paid intelligent centre checks the subscriber's balance from the account-management system 12, which can be located in the intelligent centre or in a system external to it. Thus the charging server 5 and the Pre-Paid IN communicate mutually over the bus 9 using an INAP or CAP protocol.

The protocol between the charging server 5 and the Pre-Paid IN can also be an XML or other similar protocol suitable for charging.

On the other hand, according to the invention, the Pre-Paid platform can also be a Service Node, or an account based solution, in which there is a balance-management function using a debit/credit interface.

The proxies of the various service modules 3 (GPRS, SMS, MMS, etc.) differ from each other by always having different charging models according to the technology and the business idea. In addition, the capability required by the proxy 4 in order to control the aforesaid charging models varies with the technology. For example, an SMS proxy 4 is simple, due to the simplicity of SMSs, SMS messages being generally priced at a fixed rate.

The charging model of a GPRS transmission server, on the other hand, is probably a rate based on the amount of data transferred (EUR/kilobyte). In addition, in GPRS prepaid solutions, the charging may become considerably more complicated, if, for example, the data amount (for example 100 kilobytes) that has been charged beforehand is not used after all, but part of it is returned to the user.

There are several charging models permitted by the system according to the invention, the most important of which are, for instance, period, event, volume, product, and product-package-based charging models. Further interesting models include charging models, in which access to the system is charged for by time and an additional charge is made for the content used, for example, on the basis of the amount of data transferred on the basis of ‘access+content’. An alternative charging method is to bundle the content with access to the system, in which case it is possible to use the term ‘content including access’ charging.

In the solution according to the invention, the charging definitions can be divided into two levels, of which the rules of the upper level can be, for example, access/bearer-based, service-specific, or roaming-based.

The rules of the lower level can be, for example, the following charging principles:
fixed message charge,
fixed service charge,
defined according to use of the service,
subscription-based (validity period, amount of use),
based on the amount of data transferred,
based on the duration of the data transfer,
protocol-based (URL, APN, QoS),
based on the number of recipients,
a combination of any of the above.

Each lower-level rule, or combination of them can refer to any of the upper-level rules whatever. Several lower-level rules can refer to a single upper-level rule. Such cases are, for instance, services based on an order, in which the user receives a certain level of service for a fixed service charge and pays a surplus charge for anything in excess of the level of service, either according to the amount transferred and/or to the duration of the transfer.

The upper-level model also states what and which proxies produce the charging information in the case of the service in question. For example:
if the charging model is access/bearer-specific, a GPRS proxy can act as the proxy.
if the rating is service-specific, the proxy can be an MMS/SMS proxy.

In other words, an upper-level service-specific charging model can also act as configuration data for the Pre-Paid mediator.

According to the invention, an unlimited number of proxies 4 can be added, because the proxies 4 are not visible from the Pre-Paid IN.

1. A method for managing customer accounts in connection with a Pre-Paid platform, in which method
the applications communicate with the Pre-Paid platform, wherein,
the applications are arranged to communicate with a proxy and the Pre-Paid platform correspondingly with a billing module, in which case the proxy and the billing module communicated with each other in a logically predefined manner, in which case
the proxy is used to collect and manage the services used by the customers, the billing models, and the rating, and
the billing module is used to bill the customer's Pre-Paid account, which is located on the Pre-Paid platform, or in a system behind it.

2. A method according to claim 1, wherein the proxy is used to collect the price of the services used by the user and other similar data and to transmit this data to the billing module.

3. A method according to claim 1 or 2, wherein the price data is formed according to various billing principles (for example, content+access, content including access).

4. A method, according to claim 1, wherein the proxy is used to control the delivery of the service used by the user.

5. A method, or 4, according to claim 1, wherein a service code is transmitted to the Pre-Paid platform with the aid of the call's B-number formed by the billing module.

6. A method, according to claim 1, wherein the proxies prevent services being delivered to the user, if the user's pre-paid account is empty, or if the price of the service is greater than the funds in the Pre-Paid account.

7. A method, according to claim 1, wherein the billing module (PCN) transfers to the Pre-Paid platform the real amount of the value of the service ordered by the user, in cash or other consideration, from the user's Pre-Paid account.

8. A method, according to claim 1, wherein the billing module transmits the billable data to the Pre-Paid platform, using an INAP protocol.

9. A method, according to claim 1, wherein the billing modules transmits the billable data to the Pre-Paid platform, using a CAP protocol.

10. A method, according to claim 1, wherein the node converts the price or rating data obtained from the proxy into voice-calls.

11. A method, according to claim 1, wherein the call data includes at least a B-number and a time definition.

12. A Pre-Paid mediator for managing customer accounts in connection with a Pre-Paid platform, in which mediator there are
a billings means unit for communicating with the Pre-Paid platform (8), and
at least one proxy for communicating with applications (SMS, GPRS, MMS), wherein
the data-transfer interface in the direction of the applications is formed to be logically one-way, in which case the proxies can be made modular,
the proxies include means a unit for collecting and/or managing the price and other similar data of the services used by customers, and wherein
the billing unit includes a unit for billing a customer's Pre-Paid account in the Pre-Paid platform.

13. A mediator according to claim 12, wherein the proxies are not in direct contact with the Pre-Paid platform (8).

14. A computer software product, which implements the method according to claim 1.
